(19) United States
(12) Patent Application Publication
(10) Pub. No.: US 2012/0066943 A1
(43) Pub. Date: Mar. 22, 2012

(54) Secure Badge Sleeve Device

(76) Inventor: Joseph D. Klos, Burr Hill, VA (US)

(21) Appl. No.: 12/885,152

(22) Filed: Sep. 17, 2010

(51) Int. Cl. G09F 19/00; B32B 1/02

(52) U.S. Cl. 40/1; 428/35.7

(57) ABSTRACT

In an exemplary embodiment, a device is provided comprising: a substrate having a top layer and a bottom layer made of thin and flexible plastic material. The substrate includes a plurality of pockets, each pocket having an opening. The substrate includes at least one seam configured and biased to close an opening in each pocket juxtaposed to the seam as the substrate is flexed, manipulated or moved.

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

I. Field

The invention relates to storage sleeves.

II. Background

Many hobbyists collect badges, such as Boy Scout badges. As these collections grow, there is an increasing need to safely store and conveniently display each badge. Current systems for holding badges in sleeves for three-ring binders fail to securely hold the badges. In some of the sleeves, the badges slip out of the sleeves through the openings due to gravity.

Most sleeves are made of a thicker plastic sheet material which can be relatively ridge. The thicker material has less resiliency and flexibility. Thus, the opening and stretching which may occur with conventional sleeves does not allow the contents in the sleeve to remain securely held in place or makes it very difficult to remove the contents or badge.

Thus, there is a need for secure badge sleeve system which more securely holds the badges while providing easy access.

Thus, there is a need for a secure badge sleeve system made of a thin, flexible plastic material and which contains one or more pockets for badges having an opening into the pocket which is essentially self closing during operation and manipulation of the sleeve.

### SUMMARY

The aforementioned problems, and other problems, are reduced, according to exemplary embodiments, by the badge sleeve system described herein below.

In an exemplary embodiment, a device is provided comprising: a substrate having a top layer and a bottom layer made of thin and flexible plastic material; a plurality of pockets, each pocket having an opening; and at least one seam configured and biased to close an opening in each pocket juxtaposed to the seam as the substrate is flexed, manipulated or moved.

In another exemplary embodiment, a system is provided comprising: a sleeve device and at least one envelope configured to fit within a plurality of pockets. The sleeve comprises a substrate having a top layer and a bottom layer made of thin and flexible plastic material, a plurality of pockets, each pocket having an opening, and at least one seam configured and biased to close an opening in each pocket juxtaposed to the seam as the substrate is flexed, manipulated or moved.

Other systems, methods, and/or products according to embodiments will be or become apparent to one with skill in the art upon review of the following drawings, and further description. It is intended that all such additional systems, methods, and/or products be included within this description, be within the scope of the present invention, and be protected by the accompanying claims.

### BRIEF DESCRIPTION OF THE DRAWINGS

The exemplary embodiments, objects, uses, advantages, and novel features are more clearly understood by reference to the following description taken in connection with the accompanying figures wherein:

FIG. 1A illustrates a front view of a secure badge sleeve device in accordance with some exemplary embodiments of the present invention;

FIG. 1B illustrates a plurality of layers of the badge sleeve device of FIG. 1A;

FIG. 1C illustrates an envelope in accordance with some exemplary embodiments of the present invention;

FIG. 1D illustrates a secure badge sleeve system in accordance with some exemplary embodiments of the present invention;

FIG. 2A illustrates a front view of another secure badge sleeve device in accordance with some exemplary embodiments of the present invention;

FIG. 2B illustrates a plurality of layers of the badge sleeve device of FIG. 2A;

FIG. 3 illustrates yet another secure badge sleeve system in accordance with some exemplary embodiments of the present invention;

FIG. 4 illustrates yet another badge sleeve system in accordance with some exemplary embodiments of the present invention; and

FIG. 5 illustrates an envelope with a badge in accordance with some exemplary embodiments of the present invention.

### DESCRIPTION

The word “exemplary” is used herein to mean “serving as an example, instance, or illustration.” Any configuration or design described herein as “exemplary” is not necessarily to be construed as preferred or advantageous over other configurations or designs. Furthermore, use of the words “present invention” is used herein to convey only some of the embodiments of the invention. For example, the word “present invention” would also include alternative embodiments and equivalent systems and components that one of ordinary skill the art understands. An example is that the materials used for the exemplary embodiments may be made out of man-made materials, natural materials, and combinations thereof. A further example is that the device or components of the device and system may be manufactured by machine(s), human(s) and combinations thereof.

Some of the embodiments of the invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

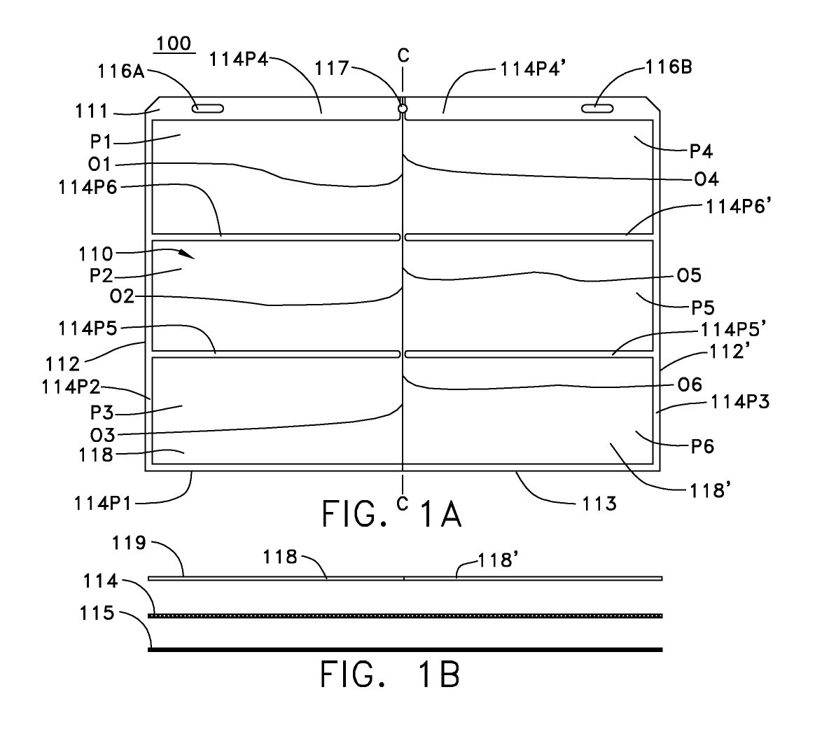

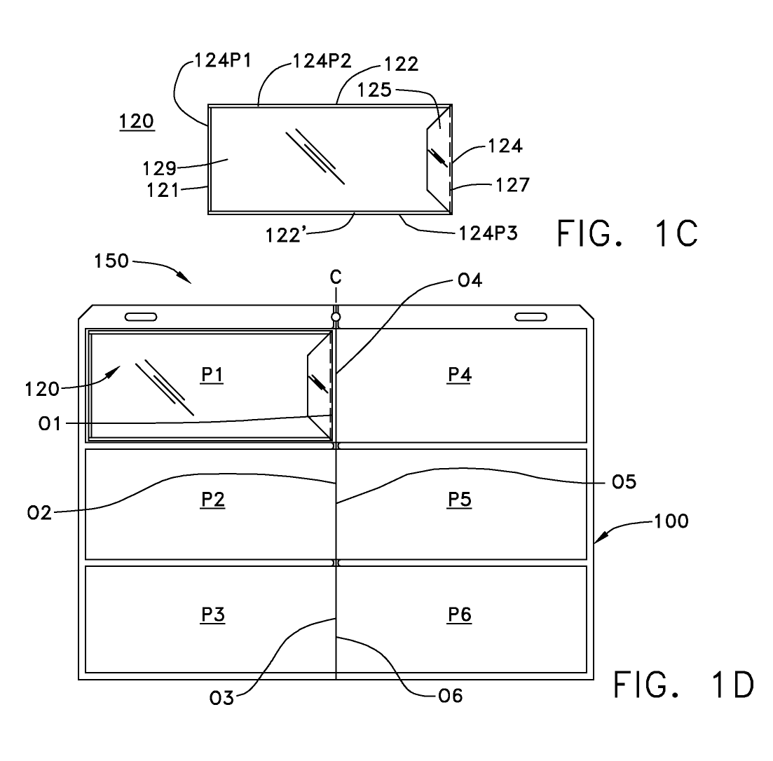

FIG. 1A illustrates a front view of a secure badge sleeve device 100 in accordance with some exemplary embodiments of the present invention. The secure badge sleeve 100 has a whole-sheet design. The secure badge sleeve device 100 includes a substrate 110 having a plurality of pockets P1, P2, P3, P4, P5 and P6 with a pocket opening O1, O2, O3, O4, O5 and O6, respectively, configured and arranged to be self-closing during operation and manipulation of the substrate 110.

The substrate 110 has a generally box, rectangular, square, or other geometric shape. In an exemplary embodiment, the shape of the substrate 110 is similar to the size of a letter size paper, legal size paper or other paper sizes for attachment of the substrate 110 in a three ring binder. As can be appreciated, other ring binders may be used with varying sizes and shapes. The shape of the badge sleeve device should be constructed, arranged and sized to fit within the binder (not shown).

In an exemplary embodiment, the substrate 110 has an outside dimension of 11.63″ by 9.25″. The pocket dimensions will vary depending on the number of pockets. While the exemplary embodiment, provide six (6) pockets more or less pockets may be made with changes to the fastening pattern strips.

The substrate 110 has a binder (first) securing side 111, second and third perpendicular sides 112 and 112′ perpendicular to the binder (first) securing side 111. The substrate 110 further includes a fourth side 113 parallel to or opposite the binder (first) securing side 111. Since the substrate 110 is square or rectangularly shaped, the fourth side 113 is also perpendicular to the second and third perpendicular sides 112 and 112′.

However, for geometric shapes of the substrate 110 not of a regular square or rectangular shape, the fourth side 113 is essentially opposite the binder (first) securing side 111.

The binder (first) securing side 111 includes a plurality of binder holes 116A, 116B and 117. The plurality of binder holes 116A, 116B and 117 are configured to correspond in spacing to the retainer rings of a standard three-ring binder (not shown) or to the ring spacing of any other binder (not shown). The binder holes 116A and 116B are opposite to the binder hole 117 wherein binder hole 117 is a center binder hole. The binder holes 116A and 116B are spaced from and on opposite sides of the center binder hole 117. In the exemplary embodiment, the spacing of the binder holes 116A and 116B from the center binder hole 117 is equidistant. The binder holes 116A and 116B are shown as elongated to adapt the hole to fit varying spacing between binder rings.

The length of the binder holes 116A and 116B is approximately 0.47-0.55 of an inch. Nonetheless, other lengths may be used.

In the exemplary embodiment, the pockets P1, P2, P3, P4, P5 and P6 are only on one side of the substrate 110. In reference also to FIG. 1B, a plurality of layers of the badge sleeve device 100 of FIG. 1A are shown. The substrate 110 of the secure badge sleeve device 100 comprises a first top sheet member 118 and a second top sheet member 118′ arranged in a side by side configuration. Together, the first top sheet member 118 and a second top sheet member 118′ provide the top or first layer 119. In the exemplary embodiment, the first top sheet member 118 and the second top sheet member 118′ together provide a surface area which substantially tracks the size and shape of the substrate 110 and thus forms the top or first layer 119. The first and second top sheet members 118 and 118′ are made of a thin lightweight and flexible sheet of clear plastic, polypropylene, polyvinyl chloride (PVC) plastic sheet or film material or 100% PVC free thin film materials. The polypropylene and 100% PVC free materials are archival safe for long term storage. PVC materials are not archival safe.

The first and second top sheet members 118 and 118′ may be a 4.5-5 mil. sheet.

The third layer 115 of the substrate 110 includes a bottom sheet member. The bottom sheet member of the third layer 115 includes a flexible sheet of clear or colored plastic, polypropylene, polyvinyl chloride (PVC) plastic sheet or film material or 100% PVC free thin film materials. The third layer 115 may be a 4.5-5 mil. sheet.

The second layer 114 includes a fastening pattern strips 114P1, 114P2, 114P3, 114P4, 114P4′, 114P5, 114P5′, 114P6 and 114P6′ configured to fasten the first and second top sheet members 118 and 118′ to create the plurality of pockets P1, P2, P3, P4, P5 and P6 with pocket openings O1, O2, O3, O4, O5 and O6, respectively.

The top or first layer 119 is transparent, clear or translucent. The third layer 115 is colored such with the color white. In an exemplary embodiment, the fastening pattern strips 114P1, 114P2, 114P3, 114P4, 114P4′, 114P5, 114P5′, 114P6 and 114P6′ are nearly transparent, clear or translucent. Thus, the substrate 110 has a colored, such as white background as provided for by the third layer 115 and a plurality of transparent, clear or translucent pockets P1, P2, P3, P4, P5 and P6 as provided for by the top or first layer 119.

In the exemplary embodiment, the pattern strips 114P1, 114P2, 114P3, 114P4 and 114P4′ are arranged along a perimeter edge of the third layer 115 of the substrate 110. The strip 114P1 coincides with the perimeter edge of fourth side 113. The strip 114P2 and 114P3 coincide with the perimeter edges of the second and third perpendicular sides 112 and 112′, respectively. The strip 114P4 coincides with the binder (first) securing side 111 of the substrate 110.

The strips 114P5 and 114P6 are arranged perpendicular to strip 114P2 and parallel to each other in spaced relation. The strips 114P5′ and 114P6′ are arranged perpendicular to strip 114P3 and parallel to each other in spaced relation. Strips 114P5 and 114P5′ are aligned in side by side arrangement but do not touch in a center of substrate 110. The strips 114P5 and 114P5′ are formed between the top or first layer and (the first top sheet member 118 and the second top sheet member 118′) and the third layer. Moreover, strips 114P5 and 114P5′ discontinue at center line C to create a folding seam.

Likewise, strips 114P6 and 114P6′ are aligned in side by side arrangement but do not touch in a center of substrate 110. The strips 114P6 and 114P6′ are formed between the top or first layer (the first top sheet member 118 and the second top sheet member 118′) and the third layer. Moreover, strips 114P6 and 114P6′ discontinue at center line C to form a seam.

Pocket P1 is created by strips or strip portions of strips 114P4, 114P2 and 114P6 used to attach the first top sheet member 118 to the third layer 115 at the location corresponding to the strips. Pocket P2 is created by strips or strip portions of strips 114P6, 114P2 and 114P5 used to attach the first top sheet member 118 to the third layer 115 at the locations corresponding to the strips. Pocket P3 is created by strips or strip portions of strips 114P5, 114P2 and 114P1 used to attach the first top sheet member 118 to the third layer 115 at the locations corresponding to the strips.

In an exemplary embodiment, the first top sheet member 118 and the second top sheet member 118′ extend from the most distal edge of the binder (first) securing side 111 of the substrate 110 to the most distal edge of the fourth side 113. Furthermore, the first top sheet member 118 extends from or nearly from the center line C to the most distal edge of the second side 112. Furthermore, the second top sheet member 118′ extends from or nearly from the center line C to the most distal edge of the third side 112′.

Pocket P4 is created by strips or strip portions of strips 114P4′, 114P3 and 114P6′ used to attach the first top sheet member 118′ to the third layer 115 at the location corresponding to the strips. Pocket P5 is created by strips or strip portions of strips 114P6′, 114P3 and 114P5′ used to attach the first top sheet member 118′ to the third layer 115 at the locations corresponding to the strips. Pocket P6 is created by strips or strip portions of strips 114P5′, 114P3 and 114P1 used to attach the first top sheet member 118′ to the third layer 115 at the locations corresponding to the strips.

The strip 114P1 may be discontinued at a center line C such that strip 114P1 may be two strips. In an exemplary embodiment, center line C divides a center of substrate 110 wherein substrate 110 has substantially one layer of material, the third layer 115.

The center line C may be horizontally oriented or vertically oriented. The orientation of the center line C and the arrangement of the pockets would cause the fastening pattern of strips to vary.

Thus, the pocket openings O1, O2, O3, O4, O5 and O6 of the plurality of pockets P1, P2, P3, P4, P5 and P6, have a direction oriented to a center of substrate 110. As can be appreciated, lifting a corner on either side of the fourth side 113, automatically, closes one or more of the pocket openings O1, O2, O3, O4, O5 and O6, as the substrate 110 may tend to bend along the seam created by the separation between first top sheet member 118 and the second top sheet member 118′ and the discontinuance of the strips 114P5, 114P5′, 114P6 and 114P6′. In an exemplary embodiment, the seam is along the same line as center line C.

While not wishing to be bound by theory, opening O3 may close opening O6 and opening O6 may close opening O3 wherein a length of the opening O3 is parallel to, aligned with, and juxtaposed with a length of the opening O6. Likewise, opening O3 and opening O6 may be closed by the third layer 115 as bending takes place along a center line C. In operation, side by side pockets P3 and P6 have juxtaposed openings with opposite directions of entry so that closing takes place when bending, flipping, moving or manipulating of the device 100. Hence, gravity acting on any contents within the pockets P3 and P6 would not be free to slip out of openings O3 or O6 as such openings would self-close during manipulation of the device 100.

While not wishing to be bound by theory, opening O2 may close opening O5 and opening O5 may close opening O2 wherein a length of the opening O2 is parallel to, aligned with, and juxtaposed with a length of the opening O5. Likewise, opening O2 and opening O5 may be closed by the third layer 115 as bending takes place along a center line C. In operation, side by side pockets P2 and P5 have juxtaposed openings with opposite directions of entry so that closing takes place when bending, flipping, moving or manipulating of the device 100. Hence, gravity acting on any contents within the pockets P2 and P5 would not be free to slip out of openings O2 or O5 as such openings would self-close during manipulation of the device 100.

While not wishing to be bound by theory, opening O1 may close opening O4 and opening O4 may close opening O1 wherein a length of the opening O1 is parallel to, aligned with, and juxtaposed with a length of the opening O4. Likewise, opening O1 and opening O4 may be closed by the third layer 115 as bending takes place along a center line C. In operation, side by side pockets P1 and P4 have juxtaposed openings with opposite directions of entry so that closing takes place when bending, flipping, moving or manipulating of the device 100. Hence, gravity acting on any contents within the pockets P1 and P4 would not be free to slip out of openings O1 or O4 as such openings would self-close during manipulation of the device 100.

In the exemplary embodiment, the device 100 includes two rows each with three pockets. Thus, pockets P1, P2 and P3 are in the same first row. The pockets P4, P5 and P6 are in the same second row. The first row is adjacent to the second row. Each row can have one or more pockets. The number of rows times the number of columns may equal the number of pockets. There may be one row with two columns.

In general, the substrate 110 has a seam is configured and biased to close an opening in a pocket as the substrate 110 is flexed, manipulated or moved.

FIG. 1C illustrates an envelope 120 in accordance with some exemplary embodiments of the present invention. The envelope 120 is made similar to the construction of the secure badge sleeve device 100 and includes three layers. The envelope 120 includes a first side 121, a second side 122, a third side 122′ and a fourth side 124. The second side 122 and the third side 122′ are parallel. The first side 121 and the fourth side 124 are parallel however; the fourth side 121 has a flap 125.

The envelope 120 includes three layers, a top or first layer 129, a second layer of fastening strips 124P1, 124P2, and 124P3 and a third layer (not shown) having an area of extension serving as flap 125. In other words, the area of extension is folded to overlap and be parallel to the top or first layer 121. The free end 127, denoted by the dashed line, of the top or first layer 121 serves an opening into the envelope when the flap 125 is raised. Thus, the free end 127 is not affixed or fastened to the third layer.

Of the fastening pattern strips 124P1, 124P2, and 124P3, strips 124P2 and 1124P3 are perpendicular. Strip 124P1 is perpendicular to strips 1124P2 and 1124P3. The strips may have a generally U-shaped pattern.

The envelope is made of a thin, lightweight and flexible sheets or sheet portions of clear plastic, polypropylene, polyvinyl chloride (PVC) plastic sheet or film material or 100% PVC free thin film materials. The envelope 120 is sized to fit the size of each pocket P1, P2, P3, P4, P5 and P6 and is capable of being slipped through each respective one of the pocket openings O1, O2, O3, O4, O5 and O6. Nonetheless other materials may be used. The plastic is relatively thin so that the contents in the envelope can be easily removed. Rigid plastics bind and sticks to the contents making it difficult to remove the contents.

FIG. 1D illustrates a secure badge sleeve (SBS) system 150 in accordance with some exemplary embodiments of the present invention. The SBS system 150 includes the secure badge sleeve device 100, as best seen in FIG. 1A and a plurality of envelops 120. However, only one envelope is shown inserted into pocket P1. The end with flap 125 of the envelope is shown adjacent to the opening O1 of pocket P1. Thus, the envelope 120 or other contents are slipped into opening O1, the envelope 120 or other contents are slipped in a first direction with respect to the center line C. On the other hand, envelope 120 or other contents are slipped into opening O4 in a second direction which is opposite that of the first direction. The first direction may be in a direction which is 180 degrees opposite that of the second direction.

The fastening strip patterns described herein may be formed by an adhesive, bond, glue, coating, or the like. Additionally, the fastening strip patterns may be created by applying the pattern to the top or first layer, the third layer or a combination of the top or first layer and third layer.

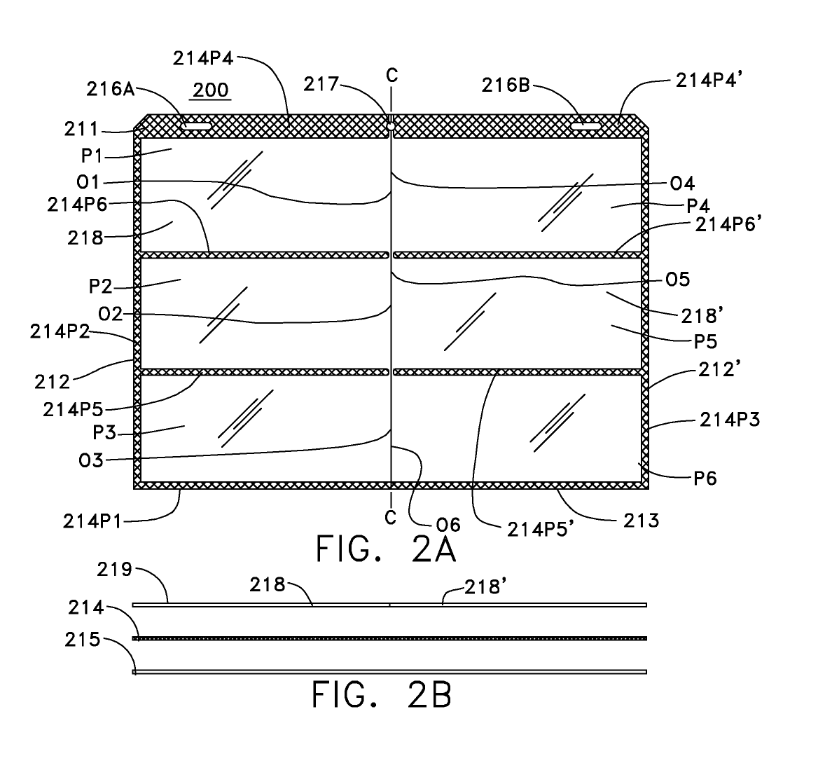

FIG. 2A illustrates a front view of another secure badge sleeve device 200 in accordance with some exemplary embodiments of the present invention. The secure badge sleeve device 200 has a whole-sheet design. The secure badge sleeve 200 is essentially the same as device 100 except as described below.

The secure badge sleeve device 200 includes a substrate 210 having a plurality of pockets P1, P2, P3, P4, P5 and P6 with a pocket opening O1, O2, O3, O4, O5 and O6, respectively, configured and arranged to be self-closing during operation and manipulation of the substrate 210.

The substrate 210 has a generally box, rectangular, square, or other geometric shape. In an exemplary embodiment, the shape of the substrate 210 is similar to the size of a letter size paper or other paper sizes for attachment of the substrate 210 in a three ring binder. As can be appreciated, other ring binders may be used with varying sizes and shapes. The shape of the badge sleeve device should be constructed, arranged and sized to fit within the binder (not shown).

The substrate 210 has a binder (first) securing side 211, second and third perpendicular sides 212 and 212′ perpendicular to the binder (first) securing side 211. The substrate 210 further includes a fourth side 213 parallel to or opposite the binder (first) securing side 211. Since the substrate 210 is square or rectangularly shaped, the fourth side 213 is also perpendicular to the second and third perpendicular sides 212 and 212′.

However, for geometric shapes of the substrate 210 not of a regular square or rectangular shape, the fourth side 213 is essentially opposite the binder (first) securing side 211.

The binder (first) securing side 211 includes a plurality of binder holes 216A, 216B and 217. The plurality of binder holes 216A, 216B and 217 are configured to correspond in spacing to the retainer rings of a standard three-ring binder (not shown) or to the ring spacing of any other binder (not shown). The binder holes 216A and 216B are opposite to the binder hole 217 wherein binder hole 217 is a center binder hole. The binder holes 216A and 216B are spaced from and on opposite sides of the center binder hole 217. In the exemplary embodiment, the spacing of the binder holes 216A and 216B from the center binder hole 217 is equidistant. The binder holes 216A and 216B are shown as elongated to adapt the hole to fit varying spacing between binder rings.

The length of the binder holes 216A and 216B is approximately 0.47-0.55 of an inch. Nonetheless, other lengths may be used.

In reference also to FIG. 2B, a plurality of layers of the badge sleeve device 200 of FIG. 2A are shown. The substrate 210 of the secure badge sleeve device 200 comprises a first top sheet member 218 and a second top sheet member 218′ arranged in a side by side configuration. Together, the first top sheet member 218 and a second top sheet member 218′ provide the top or first layer 219. In the exemplary embodiment, the first top sheet member 218 and the second top sheet member 218′ together provide a surface area which substantially tracks the size and shape of the substrate 210 and thus forms the top or first layer 219. The first and second top sheet members 218 and 218′ are made of a thin lightweight and flexible sheet of clear plastic, polypropylene, polyvinyl chloride (PVC) plastic sheet or film material or 100% PVC free thin film materials. The top or first layer 119 may be a 4.5-5 mil. sheet.

The third layer 215 of the substrate 210 includes a bottom sheet member. The bottom sheet member of the third layer 215 includes a flexible sheet of clear plastic or polyvinyl chloride (PVC) plastic sheet or film material. The third layer 215 may be a 4.5-5 mil. sheet. Other mills which are thin and flexible may be used.

The second layer 214 includes a fastening pattern strips 214P1, 214P2, 214P3, 214P4, 214P4′, 214P5, 214P5′, 214P6 and 214P6′ configured to fasten the first and second top sheet members 218 and 218′ to create the plurality of pockets P1, P2, P3, P4, P5 and P6 with a pocket opening O1, O2, O3, O4, O5 and O6, respectively.

The top or first layer 219 is transparent, clear or translucent. Likewise, the third layer 215 is transparent, clear or translucent. In an exemplary embodiment, the fastening pattern strips 214P1, 214P2, 214P3, 214P4, 214P4′, 214P5, 214P5′, 214P6 and 214P6′ are nearly transparent, clear or translucent. The hatching pattern of diagonally aligned checker boxes denotes the presence of the fastening pattern strips 214P1, 214P2, 214P3, 214P4, 214P4′, 214P5, 214P5′, 214P6 and 214P6′. However, the substrate 210 is substantially transparent, clear or translucent.

In the exemplary embodiment, the pattern strips 214P1, 214P2, 214P3, 214P4 and 214P4′ are arranged along a perimeter edge of the third layer 215 of the substrate 210. The strip 214P1 coincides with the perimeter edge of fourth side 213. The strip 214P2 and 214P3 coincide with the perimeter edges of the second and third perpendicular sides 212 and 212′, respectively. The strips 214P4 and 214P4′ coincide with the binder (first) securing side 211 of the substrate 210.

The strips 214P5 and 214P6 are arranged perpendicular to strip 214P2 and parallel to each other in spaced relation. The strips 214P5′ and 214P6′ are arranged perpendicular to strip 214P3 and parallel to each other in spaced relation. Strips 214P5 and 214P5′ are aligned in side by side arrangement but do not touch in a center of substrate 210 and discontinue at center line C. Strips 214P6 and 214P6′ are aligned in side by side arrangement but do not touch in a center of substrate 210 and discontinue at center line C.

As can be appreciated, the device 200 may be used in system 150 with envelope 120 accordingly. The device 200 is made similar to device 100.

In the exemplary embodiment, the pockets P1, P2, P3, P4, P5 and P6 are only on one side of the substrate 210.

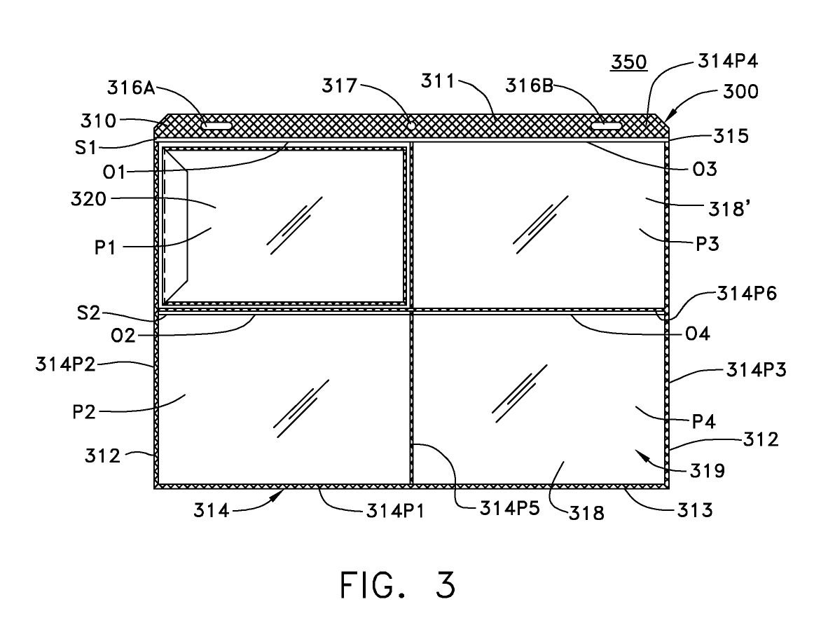

FIG. 3 illustrates yet another secure badge sleeve (SBS) system 350 in accordance with some exemplary embodiments of the present invention. The SBS system 350 includes a secure badge sleeve device 300 and optional envelope 320. The envelope 320 is similar to that described in relation to FIG. 1C. The secure badge sleeve 300 has a whole-sheet design. The secure badge sleeve device 300 includes a substrate 310 having a plurality of pockets P1, P2, P3, and P4 with a pocket opening O1, O2, O3, and O4, respectively, configured and arranged to be self-closing during operation and manipulation of the substrate 310.

The substrate 310 has a generally box, rectangular, square, or other geometric shape. In an exemplary embodiment, the shape of the substrate 310 is similar to the size of a letter size paper or other paper sizes for attachment of the substrate 310 in a three ring binder. As can be appreciated, other ring binders may be used with varying sizes and shapes. The shape of the badge sleeve device should be constructed, arranged and sized to fit within the binder (not shown).

The substrate 310 has a binder (first) securing side 311, second and third perpendicular sides 312 and 312′ perpendicular to the binder (first) securing side 311. The substrate 310 further includes a fourth side 313 parallel to or opposite the binder (first) securing side 311. Since the substrate 310 is square or rectangularly shaped, the fourth side 313 is also perpendicular to the second and third perpendicular sides 312 and 312′.

However, for geometric shapes of the substrate 310 not of a regular square or rectangular shape, the fourth side 313 is essentially opposite the binder (first) securing side 311.

The binder (first) securing side 311 includes a plurality of binder holes 316A, 316B and 317. The plurality of binder holes 316A, 316B and 317 are configured to correspond in spacing to the retainer rings of a standard three-ring binder (not shown) or to the ring spacing of any other binder (not shown). The binder holes 316A and 316B are opposite to the binder hole 317 wherein binder hole 317 is a center binder hole. The binder holes 316A and 316B are spaced from and on opposite sides of the center binder hole 317. In the exemplary embodiment, the spacing of the binder holes 316A and 316B from the center binder hole 317 is equidistant. The binder holes 316A and 316B are shown as elongated to adapt the hole to fit varying spacing between binder rings.

The length of the binder holes 316A and 316B is approximately 0.47-0.55 of an inch. Nonetheless, other lengths may be used.

The substrate 310 of the secure badge sleeve device 300 comprises a first top sheet member 318 and a second top sheet member 318′ arranged in a side by side configuration. Together, the first top sheet member 318 and a second top sheet member 318′ provide the top or first layer 319. In the exemplary embodiment, the first top sheet member 318 and the second top sheet member 318′ together provide a surface area which substantially tracks the size and shape of the substrate 310 and thus forms the top or first layer 319. The first and second top sheet members 318 and 318′ are made of a thin lightweight and flexible sheet of clear plastic or polyvinyl chloride (PVC) plastic sheet or film material. The top or first layer 119 may be a 4.5-5 mil. sheet. The top or first layer 119 may also include third top sheet member 318″.

The third layer 315 of the substrate 310 includes bottom sheet member. In the exemplary embodiment, only a portion of the third layer 315 is shown through. The bottom sheet member of the third layer 315 includes a flexible sheet of clear plastic or polyvinyl chloride (PVC) plastic sheet or film material. The third layer 315 may be a 4.5-5 mil. sheet.

The second layer 314 includes fastening pattern strips 314P1, 314P2, 314P3, 314P4, 314P5, and 314P6 configured to fasten the first and second top sheet members 318 and 318′ to create the plurality of pockets P1, P2, P3, and P4 with a pocket opening O1, O2, O3, and O4, respectively.

The top or first layer 319 is transparent, clear or translucent. Likewise, the third layer 315 is transparent, clear or translucent. In an exemplary embodiment, the fastening pattern strips 314P1, 314P2, 314P3, 314P4, 314P5, and 314P6 are nearly transparent, clear or translucent. The hatching pattern of diagonally aligned checker boxes denotes the presence of the fastening pattern strips 314P1, 314P2, 314P3, 314P4, 314P5, and 314P6. However, the substrate 310 is substantially transparent, clear or translucent. If the third layer 315 is colored such as white, then the substrate would have a colored appearance with transparent pockets.

In the exemplary embodiment, the pattern strips 314P1, 314P2, 314P3, and 314P4 are arranged along a perimeter edge of the third layer 315 of the substrate 310. The strip 314P1 coincides with the perimeter edge of fourth side 313. The strip 314P2 and 314P3 coincide with the perimeter edges of the second and third perpendicular sides 312 and 312′, respectively. The strip 314P4 coincides with the binder (first) securing side 311 of the substrate 310.

The strip 314P5 is arranged parallel to strips 314P2 and 314P3 in spaced relation. In the exemplary embodiment, strip 314P5 is nearly a center line and equidistant from strips 314P2 and 314P3. In the exemplary embodiment, strip 314P5 is perpendicular to strips 314P1 and 314P4. However, strip 314P5 may stop just short of strip 314P4.

The strip 314P6 is arranged perpendicular to strips 314P2 and 314P3. In the exemplary embodiment, strip 314P6 is nearly a center line and nearly equidistant from strips 314P1 and 314P4. The strips 314P5 and 314P6 are arranged in a cross wherein strip 314P5 is perpendicular to strip 314P6.

Pocket P1 is created by strips or strip portions of strips 314P2, 314P5 and 314P6 used to attach the second top sheet member 318′ to the third layer 315 at the location corresponding to the strips. Pocket P2 is created by strips or strip portions of strips 314P1, 314P2 and 314P5 used to attach the first top sheet member 318 to the third layer 315 at the locations corresponding to the strips.

Pocket P3 is created by strips or strip portions of strips 314P3, 314P5 and 314P6 used to attach the second top sheet member 318′ to the third layer 315 at the locations corresponding to the strips. Pocket P4 is created by strips or strip portions of strips 314P3, 314P5 and 314P6 used to attach the second top sheet member 318′ to the third layer 315 at the location corresponding to the strips.

The openings O1 and O3 are oriented in a direction with is adjacent to the binder (first) securing side 311. A fold line or seam Si is created such that the second top sheet member 318′ stops or discontinues just before the three layers defined by strip 314P4, third layer 315 and the third top sheet member 318″. At the fold line or seam S1, there is generally one layer or the third layer 315. In the exemplary embodiment, the third top sheet member 318″ includes the binder holes 316A, 316B and 317 and extends from side 312 to side 312′.

The openings O1 and O3 are is side by side relation and are juxtaposed to the binder (first) securing side 311 however, there is a discontinuity between sheet members 318′ and 318″ of the top or first layer 319. Therefore, when flipping, moving or manipulating the substrate 310, the openings O1 and O3 are generally self-closing, as the third layer 315 will tend to bend along the fold line or seam S1. The envelopes 320 or other contents are inserted in the same direction in pockets P1 and P3 through openings O1 and O3, respectively.

The openings O2 and O4 are oriented in a direction with is adjacent to the strip 314P6 and the discontinuity of sheet member 318′. A fold line or seam S2 is created such that the first top sheet member 318 stops or discontinues just before the three layers defined by strip 314P6, third layer 315 and the second top sheet member 318′. At the fold line or seam S2, there is generally one layer or the third layer 315. Therefore, when flipping, moving or manipulating the substrate 310, the openings O2 and O4 are generally self-closing, as the third layer 315 will tend to bend along the fold line or seam S2. As the substrate 310 folds, angles may be formed between sheet members 318, 318′ and 318″ which are less than 180 degrees.

The envelopes 320 or other contents are inserted in the same direction in pockets P2 and P4 through openings O2 and O4, respectively. Likewise, the envelopes or contents may be slipped or slid into pockets P2 and P4 in the same direction as pockets P1 and P3.

In the exemplary embodiment, the pockets P1, P2, P3, and P4 are only on one side of the substrate 310. Pocket P1 and P3 are on the same row but adjacent columns. Pocket P2 and P4 are on the same row but adjacent columns.

The secure badge sleeve device 300 may include more than four (4) pockets. For example, instead of two rows with two pockets each, the rows may have 2 or more pockets and the columns may have one, two or more rows wherein the number of pockets may equal the number of rows times the number of columns.

It should be understood, in the configuration of FIG. 3, each row of pockets should be separated by a seam so that the third layer 315 will tend to fold or bend so that the top or first layer sheets bend to form angles less than 180 degrees.

In general, the substrate 310 has a plurality of seams configured and biased to close an opening in a pocket juxtaposed to the seam as the substrate 110 is flexed, manipulated or moved.

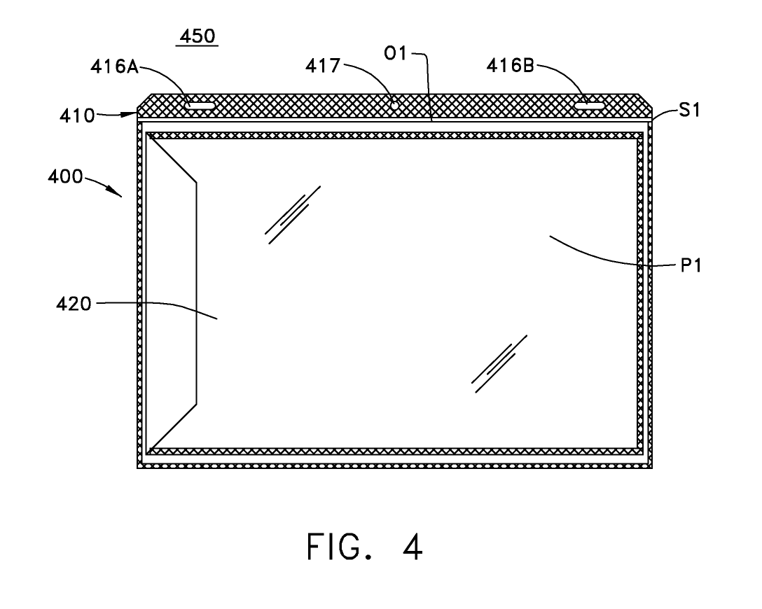

FIG. 4 illustrates yet another badge sleeve system 450 in accordance with some exemplary embodiments of the present invention. The system 450 includes a badge sleeve device 400 and an envelope 420. As can be appreciated, the envelope 420 may be omitted. The device 400 includes a substrate 410 having one pocket P1 with one opening O1 juxtapose to the binder securing side having the binder holes 416A, 416B and 417. The spacing of the binder holes 116A and 116B from the center binder hole 117 is equidistant. The opening O1 is juxtaposed to seam S1 wherein seam S1 is juxtaposed to the binder holes 416A, 416B and 417.

In operation, the device 400 may be constructed in a manner similar to devices 100 and 200 with a clear or white colored flexible and thin sheets.

The sheet members of the top or first layer 119, 219 or 319 may be secured to the sheet of the third layer by heat treatment, adhesive, or any other methods.

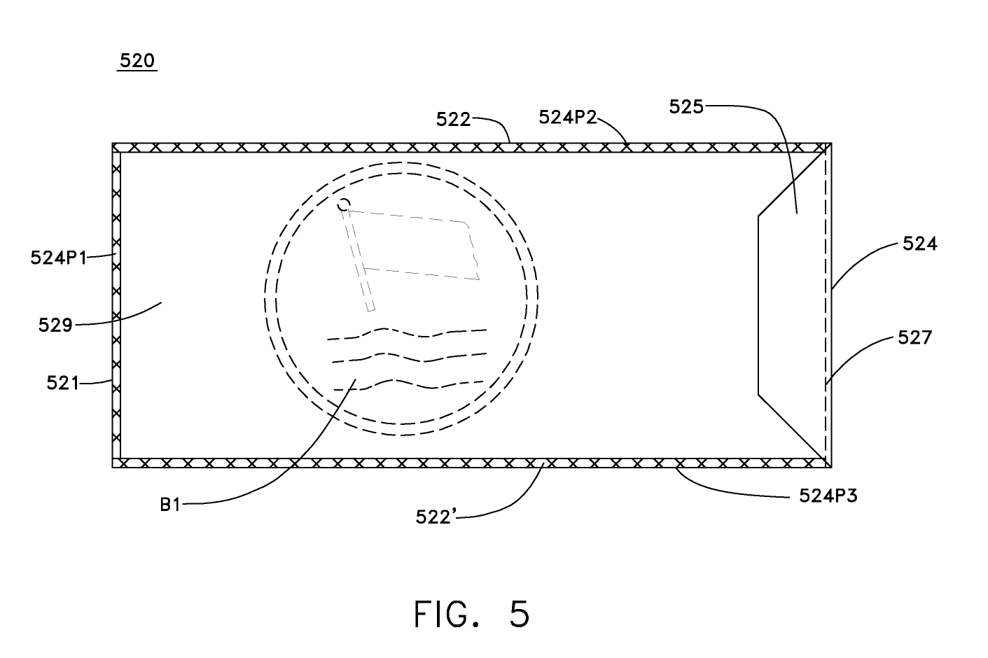

FIG. 5 illustrates an envelope 520 with a badge B1 in accordance with some exemplary embodiments of the present invention. The envelope 520 is made similar to the construction of the envelope 120. The envelope 520 includes a first side 521, a second side 522, a third side 522′ and a fourth side 524. The second side 522 and the third side 522′ are parallel. The first side 521 and the fourth side 524 are parallel however; the fourth side 521 has a flap 525.

The envelope 520 includes three layers, a top or first layer 529, a second layer of fastening strips 524P1, 524P2, and 524P3 and a third layer (not shown) having an area of extension serving as flap 525. The free end 527, denoted by the dashed line, of the top or first layer 521 serves an opening into the envelope when the flap 525 is raised. Thus, the free end 527 is not affixed or fastened to the third layer.

The envelope 520 is shown with a badge B1 represented in dashed lines inserted within the envelope 520. The envelope 520 is made of a thin, lightweight and flexible sheets or sheet portions of clear plastic, polypropylene, polyvinyl chloride (PVC) plastic sheet or film material or 100% PVC free thin film materials.

The envelope 520 size varies based on the size of the pocket.

In view of the foregoing, while the invention is described in relation to badges such as for Boy Scouts, Girl Scouts or other Troops, the stored contents may include other collectibles or items to be stored or archived.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A device comprising:
a substrate having a top layer and a bottom layer made of thin and flexible plastic material;
a plurality of pockets, each pocket having an opening; and
at least one seam configured and biased to close an opening in each pocket juxtaposed to the seam as the substrate is flexed, manipulated or moved.

2. The device according to claim 1, wherein the top layer comprises a first sheet member and a second sheet member in side by side arrangement, and the first sheet member and the second sheet member discontinue along the at least one seam.

3. The device according to claim 1, wherein the substrate comprises:
a first side having a plurality of ring hole formed therein;
a second side perpendicular to the first side;
a third side perpendicular to the first side and parallel to the second side; and
a fourth side parallel to the first side and perpendicular to the second and third sides wherein the at least one seam includes one seam extending perpendicular to the first side and the fourth side and each opening of each pocket is juxtaposed to the at least one seam.

4. The device according to claim 1, wherein the substrate comprises:
a first side having a plurality of ring hole formed therein;
a second side perpendicular to the first side;
a third side perpendicular to the first side and parallel to the second side; and
a fourth side parallel to the first side and perpendicular to the second and third sides wherein the at least one seam includes one or more seams extending perpendicular to the second side and the third side and each opening of each pocket is juxtaposed to the one or more seams.

5. The device according to claim 1, wherein the top layer and the bottom layer are made of a thin, lightweight and flexible sheet of clear plastic or polypropylene with a 4.5-5 mil.

6. The device according to claim 1, wherein the top layer is made of a thin, lightweight and flexible sheet of clear plastic or polypropylene with a 4.5-5 mil. and the bottom layer is made of a thin, lightweight and flexible white colored sheet of plastic or polypropylene with a 4.5-5 mil.

7. The device according to claim 1, wherein said each pocket is dimensioned to hold a respective one badge.

8. A system comprising:
a sleeve device comprising:
a substrate having a top layer and a bottom layer made of thin and flexible plastic material,
a plurality of pockets, each pocket having an opening, and
at least one seam configured and biased to close an opening in each pocket juxtaposed to the seam as the substrate is flexed, manipulated or moved; and
at least one envelope configured to fit within the plurality of pockets.

9. The system according to claim 8, wherein the top layer comprises a first sheet member and a second sheet member in side by side arrangement, and the first sheet member and the second sheet member discontinue along the at least one seam.

10. The system according to claim 8, wherein the substrate comprises:
a first side having a plurality of ring hole formed therein;
a second side perpendicular to the first side;
a third side perpendicular to the first side and parallel to the second side; and
a fourth side parallel to the first side and perpendicular to the second and third sides wherein the at least one seam includes one seam extending perpendicular to the first side and the fourth side and each opening of each pocket is juxtaposed to the at least one seam.

11. The system according to claim 8, wherein the substrate comprises:
a first side having a plurality of ring hole formed therein;
a second side perpendicular to the first side;
a third side perpendicular to the first side and parallel to the second side; and
a fourth side parallel to the first side and perpendicular to the second and third sides wherein the at least one seam includes one or more seams extending perpendicular to the second side and the third side and each opening of each pocket is juxtaposed to the one or more seams.

12. The system according to claim 8, wherein the top layer and the bottom layer are made of a thin, lightweight and flexible sheet of clear plastic or polypropylene with a 4.5-5 mil.

13. The system according to claim 8, wherein the top layer is made of a thin, lightweight and flexible sheet of clear plastic or polypropylene with a 4.5-5 mil. and the bottom layer is made of a thin, lightweight and flexible white colored sheet of plastic or polypropylene with a 4.5-5 mil.

14. The system according to claim 13, wherein the envelope is made of a thin, lightweight and flexible sheet of clear plastic or polypropylene with a 4.5-5 mil.

15. A device comprising:
a substrate having a top layer and a bottom layer made of thin and flexible plastic material;
a plurality of pockets, each pocket having an opening; and
a seam configured and biased to close an opening in each pocket juxtaposed to the seam as the substrate is flexed, manipulated or moved
wherein the top layer comprises a first sheet member and a second sheet member in side by side arrangement, and the first sheet member and the second sheet member discontinue along the seam; and
wherein the substrate comprises:
a first side having a plurality of ring hole formed therein;
a second side perpendicular to the first side;
a third side perpendicular to the first side and parallel to the second side;
and
a fourth side parallel to the first side and perpendicular to the second and third sides wherein the seam includes one seam extending perpendicular to the first side and the fourth side and each opening of each pocket is juxtaposed to the seam.

16. The system according to claim 15, wherein the plurality of pockets includes one or more pockets in a first row and one or more pockets in a second row and the openings into each pocket in the first row and the second row are juxtaposed to the seam.

17. The system according to claim 16, wherein the substrate is made of layers of a thin, lightweight and flexible sheet of clear plastic or polypropylene with a 4.5-5 mil.
